(19) United States
(12) Patent Application Publication
(10) Pub. No.: US 2007/0139982 A1
(43) Pub. Date: Jun. 21, 2007

(54) CHARGE PUMP CIRCUIT AND POWER SUPPLY APPARATUS

(75) Inventors: Tomotaka UENO, Osaka (JP); Takuya ISHII, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/567,962

(22) Filed: Dec. 7, 2006

(30) Foreign Application Priority Data
Dec. 19, 2005 (JP) 2005-365408

(51) Int. Cl. H02M 3/18

(52) U.S. Cl. 363/59

(57) ABSTRACT

A high efficiency charge pump circuit and a power supply apparatus that can sense the output current level and change the connection of flying capacitors. The charge pump circuit includes a switching circuit that performs a switching operation of alternately switching between the charge state of charging flying capacitor from input terminal and a discharge state of discharging flying capacitor to output terminal. A flying capacitor, one end of which is connected to a connection point between two switch elements and to the other end of which a drive signal from switching circuit is applied. A detection control section detects a voltage of flying capacitor and outputs various drive signals. The charge pump circuit detects the voltage of the flying capacitor and senses the output current that is output from output terminal according to a relationship indicating the difference between the input voltage and the initial value Vc0 of the detected voltage of flying capacitor in the charge state.

### BACKGROUND OF THE INVENTION

1. Field of the Invention

The present invention relates to a charge pump circuit and power supply apparatus for supplying a stable voltage to various types of electronic devices.

2. Description of the Related Art

Recently, electronic devices having batteries, such as mobile devices, require more than the battery voltage for display devices. Among these devices, charge pump circuits are widely used as DC-DC converters that do not use inductors, to address the need for further reduction of power consumption. The voltage converting circuit disclosed in Patent Document 1 (Japanese Patent Application Laid-Open No. 2001-218451) is an example of a prior-art charge pump circuit.

FIG. 1 is a circuit diagram for the charge pump circuit disclosed in Patent Document 1. FIG. 2 is an operation waveform chart of the charge pump circuit as shown in FIG. 1.

With reference to FIG. 1, “1” designates an input terminal where an input voltage Vi is applied, and “2” designates an output terminal. Three diodes 11, 12, and 13 are serially connected between input terminal 1 and output terminal 2. One end of flying capacitor 14 is connected to a connection point between diode 11 and diode 12, and a first input signal IN1 is applied to the other end of flying capacitor 14. One end of flying capacitor 15 is connected to a connection point between diode 12 and diode 13, and a second input signal IN2 is applied to the other end of flying capacitor 15. “16” designates a switch element, which is connected in parallel to diode 12. The output voltage of terminal 2 is Voi.

FIG. 2A shows the first input signal IN1 and second input signal 2 while switch element 16 is closed (i.e., ON). In this case, the input signals IN1 and IN2 are clock signals that are in phase with each other. When the input signals IN1 and IN2 are at a low level (i.e., ground potential), flying capacitors 14 and 15 are both connected between the input terminal and the ground via diode 11, so that a direct current input voltage Vi is charged to flying capacitors 14 and 15. Next, when the input signals IN1 and IN2 are at a high level (i.e., Vi), the discharge current is released from flying capacitors 14 and 15 via diode 13. The charged voltage Vi of flying capacitors 14 and 15 is added to the input voltage Vi. Consequently, the output voltage Voi is 2 Vi. Accordingly, while switch element 16 is closed, 2-fold voltage boost operation is carried out.

FIG. 2B shows the first input signal IN1 and second input signal IN2 while switch element 16 is open (i.e. OFF). In this case, the input signals IN1 and IN2 are clock signals that are out of phase. When the input signal IN1 is at the low level and the input signal IN2 is at the high level, flying capacitor 14 is charged to the direct current input voltage Vi, and, at the same time, flying capacitor 15 discharges the current to output terminal 2. Next, when the input signal IN1 is at the high level and the input signal IN2 is at the low level, flying capacitor 14 discharges the current to flying capacitor 15 via diode 12. The voltage of flying capacitor 15 becomes 2×Vi, adding the charge voltage Vi of flying capacitor 14 to the direct input voltage Vi, and, the output voltage becomes 3×Vi, adding the charge voltage 2×Vi of flying capacitor 15 to the direct input voltage Vi. Accordingly, while switch element 16 is open, 3-fold voltage boost operation is carried out.

As mentioned above, by adequately switching between 2-fold voltage boost operation and 3-fold voltage boost operation, the charge pump circuit shown in FIG. 1 can be applied to a high efficiency power converting circuit.

Although no illustration is provided, patent document 1 also discloses configurations such as configurations for other, N-fold voltage boost operations, configuration replacing switch elements with diodes, configuration detecting the input voltage Vi or output voltage Voi for operation switching.

This prior-art charge pump circuit has a disadvantage that the output current level cannot be sensed adequately. Consequently, power conversion efficiency is greatly reduced without optimal switching operation of a flying capacitor.

For example, when the connection of a flying capacitor is changed based solely on input voltage detection, even when voltage drop is little in the state of light-load current and therefore can be compensated for by means of 2-fold voltage boost operation, the connection may maintain 3-fold voltage boost operation, which then may reduce power conversion efficiency. If both the input voltage and the output voltage are detected, adjustment can be made depending on the level of the output current. However, this configuration has a disadvantage that elements that can withstand high voltage are required in the output voltage detection section for N-fold voltage boost operations requiring high output voltage. Providing a detection element on the output side of a charge pump circuit only for the above switching operation alone will lead to increased costs. If the detection element can withstand high voltage, it may further increase the cost.

### SUMMARY OF THE INVENTION

It is therefore an object of the present invention to provide a high efficiency charge pump circuit and a power supply apparatus that can sense the output current level using a detection point other than the output and a simple circuit and that can change the connection of a flying capacitor according to the sensed results.

According to an aspect of the invention, a charge pump circuit employs a configuration having: an input terminal and an output terminal; at least one flying capacitor; a plurality of switch elements; a switching circuit that performs a switching operation of alternately switching between a charge state of charging an electric charge of the flying capacitor from the input terminal and a discharge state of discharging the electric charge of the flying capacitor to the output terminal; and a detection section that detects a voltage of the flying capacitor and senses an output current from the output terminal based on the detected voltage.

According to another aspect of the invention, a charge pump circuit employs a configuration having: an input terminal and an output terminal; a first switch element and a second switch element serially connected between the input terminal and the output terminal; at least one flying capacitor, one end of said flying capacitor being connected to a connection point between the first switch element and the second switch element; a switching circuit that performs a switching operation of alternately switching between a charge state of charging the flying capacitor from the input terminal and a discharge state of discharging the flying capacitor to the output terminal with a plurality of switch elements including the first switch element and the second switch element; and a detection section that detects a voltage of the flying capacitor and senses an output current from the output terminal based on the detected voltage.

According to yet another aspect of the present invention, a power supply apparatus employs a configuration having: a flying capacitor; a switching circuit that performs a switching operation of alternately switching between the charge state of charging the electric charge of the flying capacitor from the input terminal and the discharge state of discharging the electric charge of the flying capacitor to the output terminal; and a detection section that detects a voltage of the flying capacitor and senses an output current output from the output terminal based on the detected voltage.

### BRIEF DESCRIPTION OF THE DRAWINGS

The above and other objects and features of the invention will appear more fully hereinafter from a consideration of the following descriptions taken in connection with the accompanying drawings, in which:

FIG. 1 is a circuit configuration for a prior-art charge pump circuit;

FIG. 2A shows the operation waveforms of the charge pump circuit shown in FIG. 1;

FIG. 2B shows the operation waveforms of the charge pump circuit shown in FIG. 1;

FIG. 3 is a circuit configuration diagram for a charge pump circuit according to Embodiment 1 of the present invention;

FIG. 4 is a circuit configuration diagram for a detection control section of the charge pump circuit according to Embodiment 1 of the present invention;

FIG. 5 shows the operation waveforms of the charge pump circuit according to Embodiment 1 of the present invention;

FIG. 6 is a circuit configuration diagram for a charge pump circuit according to Embodiment 2 of the present invention;

FIG. 7 shows the operation waveforms at individual operation points of the charge pump circuit according to Embodiment 2 in 1.5-fold voltage boost operation;

FIG. 8 shows the operation waveforms at individual operation points according to the above-mentioned Embodiment 2 of the present invention upon transition of the charge pump circuit from 1.5-fold voltage boost operation to 1.0-fold voltage boost operation;

FIG. 9 shows output characteristics of the charge pump circuit according to Embodiment 2 of the present invention;

FIG. 10 is a circuit configuration diagram for a charge pump circuit according to Embodiment 3 of the present invention;

FIG. 11 shows the operation waveforms at individual operation points of the charge pump circuit shown in Embodiment 3 in 3-fold voltage boost operation;

FIG. 12 shows the operation waveforms at individual operation points of the charge pump circuit according to Embodiment 3 in 2-fold voltage boost operation;

FIG. 13 shows input and output characteristics of the charge pump circuit according to Embodiment 3 of the present invention;

FIG. 14 is another circuit configuration diagram for a charge pump circuit that operates in 2-fold voltage boost;

FIG. 15A shows the operation waveforms of the charge pump circuit of FIG. 14;

FIG. 15B shows the operation waveforms of the charge pump circuit of FIG. 14;

FIG. 16 is another circuit configuration diagram for a charge pump circuit that operates in 2-fold voltage boost;

FIG. 17A shows the operation waveforms of the charge pump circuit of FIG. 16;

FIG. 17B shows the operation waveforms of the charge pump circuit of FIG. 16;

FIG. 18 is another circuit configuration diagram for a charge pump circuit that operates in 2-fold and 1.5-fold voltage boost;

FIG. 19A shows the operation waveforms of the charge pump circuit of FIG. 18;

FIG. 19B shows the operation waveforms of the charge pump circuit of FIG. 11;

FIG. 20 is a circuit configuration diagram for a voltage step-down voltage charge pump circuit that operates in 0.5-fold voltage boost; and

FIG. 21A shows the operation waveforms of the voltage step-down voltage charge pump circuit of FIG. 20.

FIG. 21B shows the operation waveforms of the voltage step-down voltage charge pump circuit of FIG. 20.

### DETAILED DESCRIPTION OF THE PREFERRED EMBODIMENT

Preferred embodiments of the present invention will now be described below in detail with reference to the accompanying drawings.

### Embodiment 1

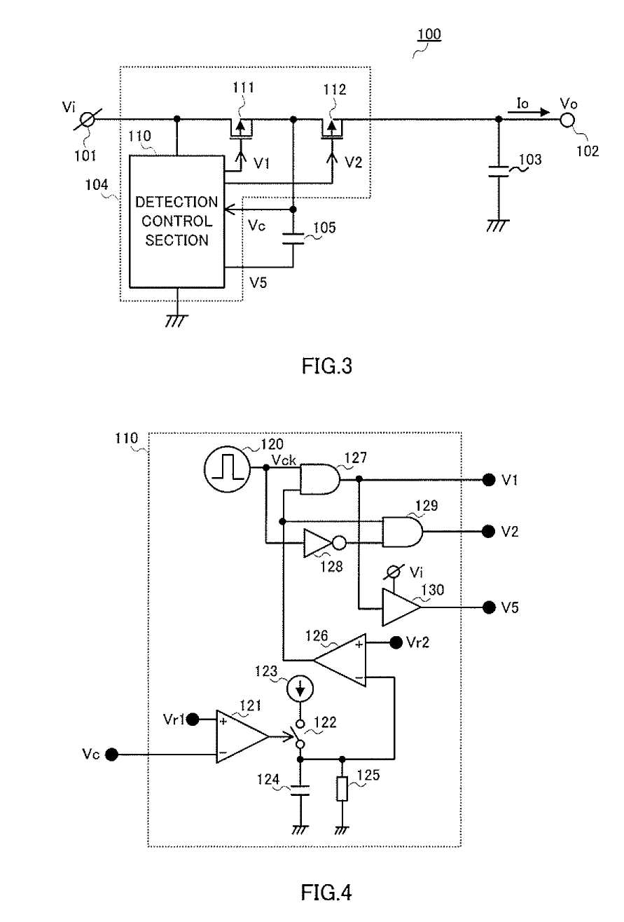

FIG. 3 is a circuit configuration diagram of a charge pump circuit according to Embodiment 1 of the present invention. This embodiment will describe a case of adopting a charge pump circuit operates in 2-fold voltage boost.

With reference to FIG. 3, charge pump circuit 100 comprises: input terminal 101, to which an input voltage Vi is applied; output terminal 102, which outputs an output voltage Vo and an output current Io; output capacitor 103, which is connected between output terminal 102 and the ground to smooth the output of charge pump circuit 100; detection control section 110, which detects the voltage of flying capacitor 105 and senses the output current from output terminal 102; switching circuit 104, which is formed with switch element 111 and switch element 112 of PMOS transistors; and flying capacitor 105, one end of which is connected to a connection point between switch element 111 and switch element 112 and the other end of which is applied a drive signal V5 from switching circuit 104.

Switching circuit 104, comprising switch elements 111 and 112, performs switching operation of alternately switching between the charge state of charging flying capacitor 105 from input terminal 101 and the discharge state and the discharge state of discharging flying capacitor 105 to output terminal 102.

Detection control section 110 detects a voltage Vc of the connection point between switch element 111 and switch element 112 and outputs a drive signal V1 for driving switch element 111, a drive signal V2 for driving switch element 112, and a drive signal V5.

Switch element 111 and switch element 112 are serially connected between input terminal 101 and output terminal 102. FIG. 4 is a circuit configuration diagram for above detection control section 110.

With reference to FIG. 4, detection control section 110 comprises oscillation circuit 120, comparator 121, switch 122, capacitor 124, resistor 125, comparator 126, AND circuit 127, inverter 128, AND circuit 129, and buffer circuit 130.

Oscillation circuit 120 outputs a clock signal Vck of a 50% duty cycle. Comparator 121 compares a detected voltage Vc and a reference voltage Vr1, outputs the comparison result to switch 122 and closes or opens switch 122.

Current source circuit 123 charges capacitor 124 when switch 122 is closed. Resistor 125 is connected in parallel to capacitor 124.

Comparator 126 compares the voltage of capacitor 124 with a reference voltage Vr2 and outputs the comparison result to AND circuits 127 and 129.

AND circuit 127 performs AND operation of the output of comparator 126 and the clock signal Vck and outputs the drive signal V1. AND circuit 129 performs AND operation of the output of comparator 126 and an output of inverter 128, which inverts the clock signal Vck, and outputs the drive signal V2. Buffer circuit 130 amplifies the power of the drive signal V1 and outputs the drive signal V5.

Now the operation of the above-configured charge pump circuit 100 will be described. First, the basic operation will be described.

An input voltage Vi is applied to input terminal 101 of charge pump circuit 100. Switch elements 111 and 112 are serially connected between input terminal 101 and output terminal 102. One end of flying capacitor 105 is connected to a connection point between switch elements 111 and 112, and the drive signal V5 received from detection control section 110 is applied to the other end of flying capacitor 105.

Detection control section 110 detects the voltage Vc (voltage of flying capacitor 105) at the connection point between switch elements 111 and 112 and outputs a drive signal V1 for driving switch element 111, a drive signal V2 for driving switch element 112, and a drive signal V5. Switch element 111 and switch element 112 close and open in response to the drive signal V1 and the drive signal V2 and performs a switching operation of alternately switching the state of flying capacitor 105 between the charge state where flying capacitor 105 is charged from input terminal 101 and the discharge state where flying capacitor 105 discharges the current to output terminal 102.

Output terminal 102 outputs an output voltage Vo and an output current Io boosted by charge pump circuit 100. Output capacitor 103 is connected between output terminal 102 and the ground and smoothes the output of charge pump circuit 100.

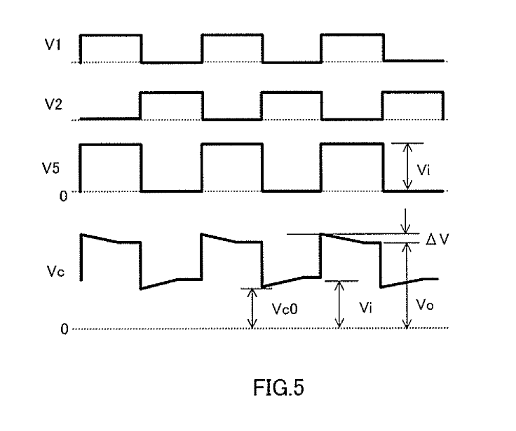

Now, how 2-fold voltage boost operation in which the output voltage Vo is boosted to twice the input voltage Vi is possible and how the output current Io can be detected from the detected voltage Vc, will be explained with reference to the operation waveforms of individual operation points. FIG. 5 shows the operation waveforms for charge pump circuit 100, corresponding to the signal waveforms of the individual points in FIG. 3, a drive signal V1, a drive signal V2, a drive signal V5, and a detected voltage Vc.

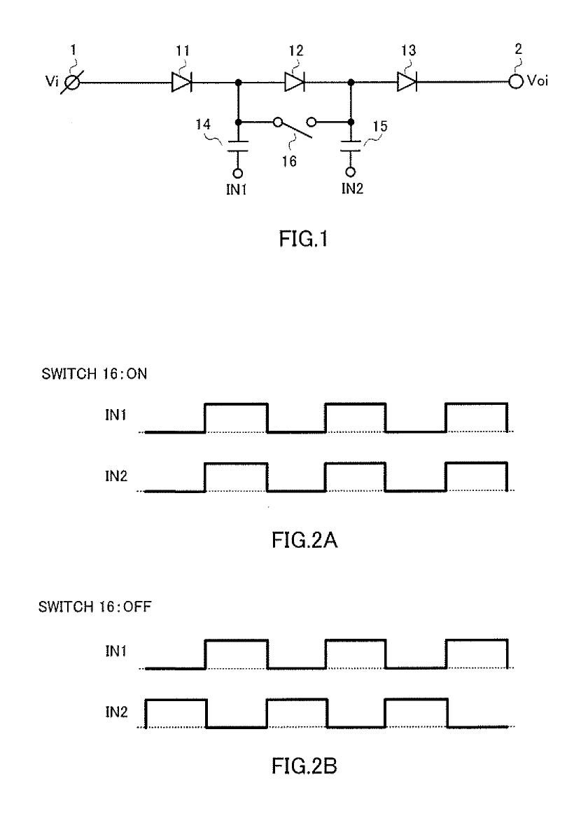

With reference to FIG. 1, detection control section 110 in switching circuit 104 alternately closes and opens switch element 111 and switch element 112 in response to the drive signal V1 and drive signal V2 according to an internally or externally supplied clock signal of a 50% duty cycle. When switch element 111 is closed and switch element 112 is open, the drive signal V5 is at the low level (0 V). When switch element 111 is open and switch element 112 is closed, the drive signal V5 is at the high level (Vi).

Based on the above operation, when switch element 111 is closed and switch element 112 is open, the input voltage Vi is charged to flying capacitor 105. When switch element III is open and switch element 112 is closed, connection is established between input terminal 101 and output terminal 102, and flying capacitor 105 discharges the current to output terminal 102. If the resistance occurring when the switch elements are closed and the voltage variation caused by the charge and discharge of flying capacitor 105 are ignored, the output voltage Vo becomes 2×Vi, adding the input voltage Vi and the charge voltage Vi of flying capacitor 105. In practice, voltage variation cannot be ignored. With reference to FIG. 5, the waveform of the detected voltage Vc rises during charge and drops during discharge.

The output current Io is expressed by the following equation (1):
Io=f·C·ΔV (1)
where f indicates the frequency of the clock signal, C indicates the capacitance of flying capacitor 105, and ΔV indicates the value of voltage variation of the detected voltage Vc during charge and discharge.

If flying capacitor 105 has sufficient time for charge and discharge, the voltage variation ΔV is expressed as follows:
ΔV=2Vi-Vo

From the above expression (1), the relationship between the input voltage and the output voltage is expressed by the following equation (2):
Vo=2Vi-Io/(f·C) (2)

The initial value of the detected voltage Vc is expressed as Vi-ΔV in a state where the input voltage Vi is charged to flying capacitor 105. From the above expression (1), this initial value Vc0 is expressed as the following expression (3) and falls in proportion to the output current Io. Accordingly, the output current level can be sensed from the detected voltage Vc (see FIG. 3).
Vc0=Vi-ΔV=Vi-Io/(f·C) (3)

Next, the operation of detection control section 110 in switching circuit 104 will be described.

With reference to FIG. 4, during normal operation, the detected voltage Vc is higher than the reference voltage Vr1, switch 122 is open, and capacitor 124 is discharged by resistor 125. Thus comparator 126 outputs a high level signal, so that the drive signal V1 and drive signal V5 are in phase with the clock signal Vck and the drive signal V2 is out of phase with the clock signal Vck. When the output current Io is large and the heavy load ensues, the period the detected voltage Vc is lower than a reference voltage Vr1 becomes longer, and, as the time switch 122 is closed becomes longer, capacitor 124 is charged more. When the voltage of capacitor 124 exceeds a reference voltage Vr2, comparator 126 outputs a low level signal. D circuit 127 and AND circuit 129 allow the drive signals V1, V2, and V5 to go low, thus terminating the operation of charge pump circuit 100. As mentioned above, according to Embodiment 1 of the present invention, charge pump circuit 100 comprises: a first switch element 111 and a second switch element 112 serially connected between input terminal 101 and output terminal 102; switching circuit 104 which performs switching operation of alternately switching between the charge state of charging flying capacitor 105 from input terminal 101 and the discharge state of discharging flying capacitor 105 to output terminal 102, with switch elements 111 and 112; flying capacitor 105, one end of which is connected to a connection point between switch element 111 and switch element 112 and the other end of which is applied a drive signal V5 from switching circuit 104; and detection control section 110 which detects the voltage Vc of flying capacitor 105 and outputs the drive signal V1 for driving switch element 111, drive signal V2 for driving switch element 112, and drive signal V5, and, in this charge pump circuit 100, detection control section 110 detects the voltage Vc of flying capacitor 105, and senses the output current Io from output terminal 102 based on the relationship equation (3) determining the difference between the input voltage Vi and the initial value Vc0 of the detected voltage Vc of flying capacitor 105 in the charge state so that the output current level can be sensed using a detection point other than the output terminal and a simple circuit without using a detection element that can withstand a high voltage on the output terminal side.

In general, elements that can withstand high voltage are expensive and require a large footprint, and, consequently, they are prohibitive in terms of costs and implementations, but this embodiment can meet this need. Further, the connection of flying capacitor 105 can be changed according to the sensed results of the output current. For example, the output current level can be sensed from the detected voltage Vc of flying capacitor 105, thus protecting a overload operation.

This applies not only to charge pump circuit 100, but also to a power supply apparatus, and the same advantage can be achieved. In general, a power supply apparatus comprising a switching circuit as a circuit element which performs a switching operation of alternately switching the charge state of charging a flying capacitor from an input terminal and the discharge state of discharging the current from the flying capacitor to an output terminal the output current can be detected from the internal state of the switching circuit without installing a detection element on the output terminal side. Accordingly, this embodiment has a unique advantage that the output current can be sensed based on internal information of a switching circuit as opposed to conventional circuits which do not or cannot detect the output current.

In this embodiment, PMOS transistors are used for switch element 111 and switch element 112, but any switch elements may be used, provided that they are capable of switching operations.

In this embodiment, PMOS transistors are used for switch element 111 and switch element 112, and so, when the drive signal V1 and drive signal V2 are at a low level, the switch elements close. However, in the following descriptions of other embodiments, switch elements will be described in a general manner, and these switch elements are closed when the drive signal is at a high level.

### Embodiment 2

A charge pump circuit and current detection function for 2-fold voltage boost operation were described with Embodiment 1, and, in addition, an over-current protection circuit was described as an example of that current detection function.

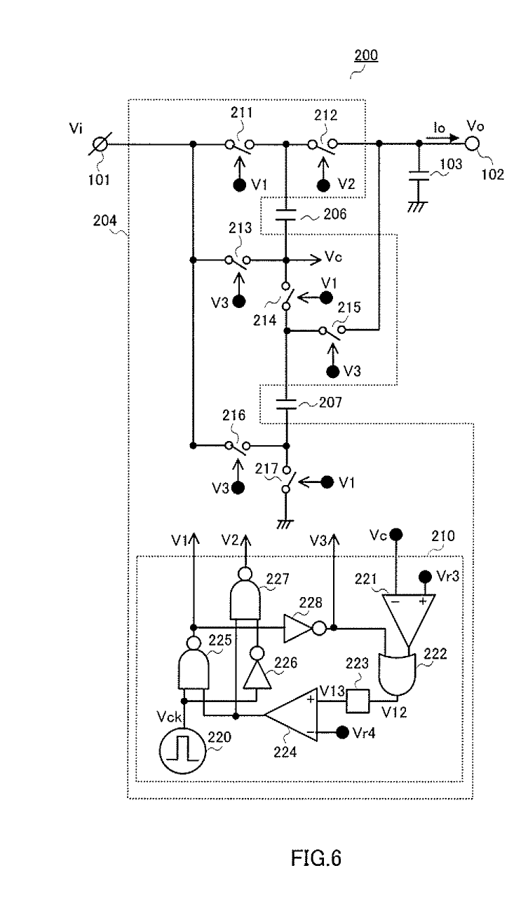

With this embodiment, a charge pump circuit and current detection function for 1.5-fold voltage boost operation will be described, and, in addition, switch between 1.5-fold voltage boost operation and 1.0-fold voltage boost operation will be described as an example of that current detection function. FIG. 6 is a circuit configuration diagram of a charge pump circuit according to Embodiment 2 of the present invention. With reference to FIG. 4, for a description of this embodiment, the same numbers are assigned to the same parts as in FIG. 3.

With reference to FIG. 6, charge pump circuit 200 comprises: input terminal 101 to which an input voltage Vi is applied; output terminal 102 which outputs an output voltage Vo and an output current Io; output capacitor 103 which is connected between output terminal 102 and the ground and smoothes an output from the charge pump circuit 200; detection control section 210; switching circuit 204 which is comprised of switch element 211, switch element 212, switch element 213, switch element 214, switch element 215, switch element 216 and switch element 217; first flying capacitor 206, one end of which is connected to a connection point between switch element 211 and switch element 212 and the other end of which is connected to a connection point between switch element 213 and switch element 214 (i.e., a detection point); and second flying capacitor 207, one end of which is connected to a connection point between switch element 214 and switch element 215 and the other end of which is connected to a connection point between switch element 216 and switch element 217. First flying capacitor 206 and second flying capacitor 207 have the same capacitance C.

Switch element 211 and switch element 212 are serially connected between input terminal 101 and output terminal 102. Switch element 213, switch element 214, and switch element 215 are also serially connected between input terminal 101 and output terminal 102. Switch element 216 and switch element 217 are serially connected between input terminal 101 and ground.

Detection control section 210 comprises: oscillation circuit 220 which outputs a clock signal Vck of a 50% duty cycle; comparator 221 which compares the detected voltage Vc with a reference voltage Vr3; OR circuit 222 which receives the output of comparator 221 and a drive signal V3, and outputs a signal V12; averaging circuit 223 which averages the output of comparator 221 and outputs a signal V13; comparator 224 which compares the output of averaging circuit 223 with a reference voltage Vr4; NAND circuit 225 which receives the output of comparator 224 and the clock signal Vck, and outputs a drive signal V1; inverter 226 which inverts the clock signal Vck; NAND circuit 227 which receives the output of comparator 224 and the output of inverter 226, and outputs a drive signal V2; and inverter 228 which inverts the drive signal V1 and outputs a drive signal V3.

Detection control section 210 detects the voltage Vc of a connection point between switch element 213 and switch element 214, and outputs a drive signal V1 for driving switch element 211, switch element 214, and switch element 217; a drive signal V2 for driving switch element 212;a drive signal V5 for driving switch element 213, switch element 215, and switch element 216.

Now, the above-configured charge pump circuit 200 will be described.

[1.5-Fold Voltage Boost Operation]

First, 1.5-fold voltage boost operation will be described, in which the output voltage of charge pump circuit 200 is 1.5 times the input voltage Vi when the output current Io is large.

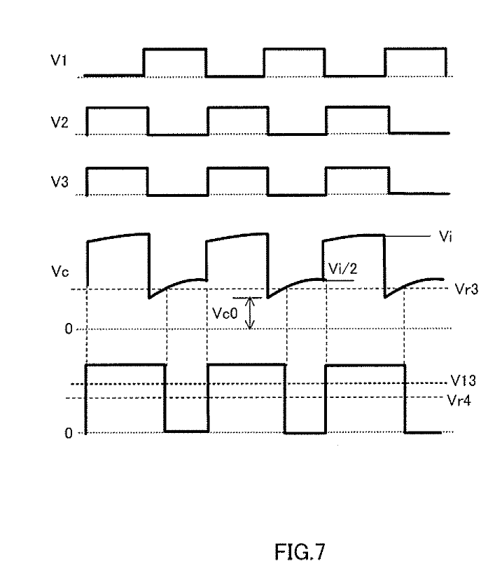

FIG. 7 shows the operation waveforms for individual operation points of charge pump circuit 200 in 1.5-fold voltage boost operation, where the waveforms include drive signal V1, drive signal V2, and drive signal V3, detected voltage Vc, and V13, which is the output of averaging circuit 223, and which is the average value of the logical sum V12 of the output of comparator 221 and drive signal V12.

With reference to FIG. 7, during 1.5-fold voltage boost operation, the drive signal V2 is in phase with the drive signal V3, but is out of phase with the drive signal V1. When the drive signal V1 is at a high level, switch elements 211, 214 and 217 close, and the other switch elements open. At this time, first flying capacitor 206 and second flying capacitor 207 are serially connected and are applied an input voltage Vi, providing a charge state where the charge current flows. If the period of charge is enough, both flying capacitors reach Vi/2, which is half the input voltage. When the drive signal Vi is at a low level, switch elements 212, 213, 215, and 216 close, and the other switch elements open. At this time, first flying capacitor 206 and second flying capacitor 207 are connected in parallel and are connected between input terminal 101 and output terminal 102, providing a discharge state. If the resistance occurring when the switch elements are closed and the voltage variation due to the charge or discharge of the flying capacitors are ignored, the output voltage Vo becomes 1.5 times the input voltage Vi, which is produced by adding an input voltage Vi and half the charged voltage Vi of a flying capacitor. In practice, the above voltage variation cannot be ignored. Although no illustration is provided, the voltages of both flying capacitors provide waveforms that rise during and drop during discharge. Consequently, as shown with Vc in FIG. 7, the detected voltage Vc rises from the initial value Vc0 to in the charge state, and drops from the input voltage Vi by the voltage of switch element 213 in the discharge state.

The output current Io is expressed by the following equation (4):
Io=2f·C·ΔV (4)
where f indicates the frequency of the clock signal, and ΔV indicates the value of voltage variation of the detected voltage Vc in the charge state. If first flying capacitor 206 and second flying capacitor 207 have sufficient time for charge and discharge, the voltage variation ΔV is expressed by:
ΔV=Vi/2-(Vo-Vi)=1.5Vi-Vo
From the above equation (4), the relationship of the input voltage and the output voltage is expressed by the following equation (5):
Vo=1.5Vi-Io/(2f·C) (5)

The initial value of the detected voltage Vc is expressed as Vi/2-ΔV in the charge state where an input voltage Vi is charged in first flying capacitor 206.

From the above equation (4), this initial value Vc0 is expressed as the following equation (6) and decreases in proportion to the output current Io. Accordingly, the output current level can be sensed from the detected voltage Vc.
Vc0=Vi/2-ΔV=Vi/2-Io/(2f·C) (6)

Next, the operation of detection control section 210 will be described.

In the state of heavy load where the output current lo is larger than a predetermined value, the initial value Vc0 of the voltage Vc detected in the charge state is lower than a reference voltage Vr3 and comparator 221 generates a pulse. The logical sum V12 of this pulse and drive signal V3 is averaged in averaging circuit 223 and produces the voltage V13, and, when this voltage V13 is larger than a reference voltage Vr4, the comparator 224 outputs a high level signal. By NAND circuit 225 and NAND circuit 227, the drive signal V1 is made a signal out of phase with the clock signal Vck and output, and the drive signals V2 and drive signal V3 are made signals out of phase with the clock signal Vck and output.

[Switching Operation Between 1.0-Fold Voltage Boost Operation and 1.5-Fold Voltage Boost Operation]

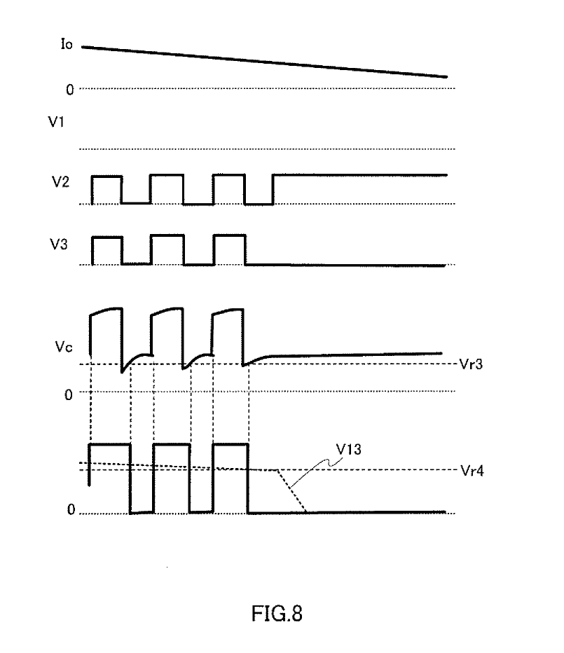

FIG. 8 shows the operation waveforms for individual operation points of charge pump circuit 200 shifting from 1.5-fold voltage boost operation to 1.0-fold voltage boost operation, and the waveforms include the output current Io, drive signal V1, drive signal V2, drive signal V3, detected voltage Vc, and V13, which is the output of averaging circuit 223, and which is the average value of the logical sum V12 of the output of comparator 221 and drive signal V12. The 1.0-fold voltage boost operation refers to the mode of operation where the output voltage Vo is roughly equal to the input voltage Vi.

In detection control section 210, when the output current Io is lower than a predetermined value, the initial value Vc0 of the voltage Vc in the charge state increases, and the width of the pulse output from comparator 221 becomes narrower. The logical sum V12 of this narrowed pulse and the drive signal V3 is averaged in averaging circuit 223 to produce V13. When this voltage V13 is smaller than a reference voltage Vr4, comparator 224 outputs a low level signal. NAND circuit 225 and NAND circuit 227 fix the drive signals V1 and V2 at a high level and the drive signal V3 at a low level (see V1-V3 in FIG. 8).

Then, switch elements 211, 212, 214, and 217 close and the other switch elements open. As a result, input terminal 101 and output terminal 102 are shorted via switch element 211 and switch element 212, thus providing 1.0-fold voltage boost operation. If the resistance occurring when the switch elements are on is ignored, the output voltage Vo is the same as the input voltage Vi, and first flying capacitor 206 and second flying capacitor 207 are serially connected, and the input voltage Vi is applied. In practice, the influence of resistance occurring when the switch elements are closed cannot be ignored, and, as shown in FIG. 8, detected voltage Vc falls between Vi/2 and Vo/2 according to the ratio of resistance switch element 211 and switch element 212 when they are closed, as shown in FIG. 8. The output voltage Vo and the detected voltage Vc are expressed as the following expressions (7) and (8), respectively.
Vo=Vi-2Ron·Io (7)
Vc=(Vi-Ron-Io)/2 (8)
where Ron indicates the resistance occurring when switch element 211 and switch element 212 are closed, provided that both switch elements have the same resistance. Detection control section 210 fixes the drive signal V3 to a low level and the level of the detected voltage Vc is as shown in the above expression (8), so that the voltage V13 becomes 0 V, assuring 1.0-fold voltage boost operation.

From 1.0-fold voltage boost operation to 1.5-fold voltage boost operation, the output current Io becomes larger and the detected voltage Vc decreases by the voltage drop caused by the resistance occurring when switch element 211 is closed and becomes less than the reference voltage Vr3. If Vol is the lower limit that needs to be secured for the output voltage Vo, from the above equation (7), the output current Iox, whereby the output voltage Vo in 1.0-fold voltage boost operation becomes the lower limit Vol, is expressed as Iox=(Vi−Vol)/(2Ron)

When this expression is assigned in the above equation (8), the detected voltage Vcx of when the output current is Iox is expressed as the following equation (9):
Vcx=(Vi+Vol)/4 (9)

A value with a margin on top of this Vcx may be set for the reference voltage Vr3.

Upon shift to 1.5-fold voltage boost operation, the detected voltage Vc has the waveform shown in FIG. 7, yet, preferably, Vc0 is less than Vr3 (f·C·Ron<1 from the above expressions (6) to (9)) and in addition, the averaged value V13 is slightly higher than the reference voltage Vr4.

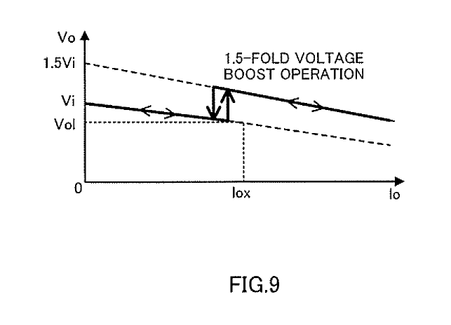

FIG. 9 shows the characteristics of the output voltage Vo and the output current Io of charge pump circuit 200 operating as described above. FIG. 9 shows the output characteristics of charge pump circuit 200. By changing the timing of switching the switch elements between the case of the shift from 1.0-fold voltage boost operation to 1.5-fold voltage boost operation and the case of the shift from 1.5-fold voltage boost operation to 1.0-fold voltage boost operation, hysteresis is provided to prevent the switching operations from hunting.

As explained above, according to this embodiment, charge pump circuit 200 senses the output current level from the voltage Vc of the low potential side of first flying capacitor 206, providing the same advantage as in Embodiment 1—that is, sensing the output current level using a detection point other than the output and a simple circuit and changing the connection of flying capacitors 206 and 207 based on the sensed results. Accordingly, this embodiment is able to switch between 1.5-fold voltage boost operation and 1.0-fold voltage boost operation.

This embodiment does not take into consideration the variation of the input voltage Vi, but this problem can be solved by providing input correction to a reference voltage Vr3 and a reference voltage Vr4.

### Embodiment 3

Switch between 1.5-fold voltage boost operation and 1.0-fold voltage boost operation was described with Embodiment 2 as an example of applying a current detection function to a charge pump circuit for 1.5-fold voltage boost operation. In this embodiment, switch between 2-fold voltage boost and 3-fold voltage boost with an addition of a voltage stabilizing function will be described.

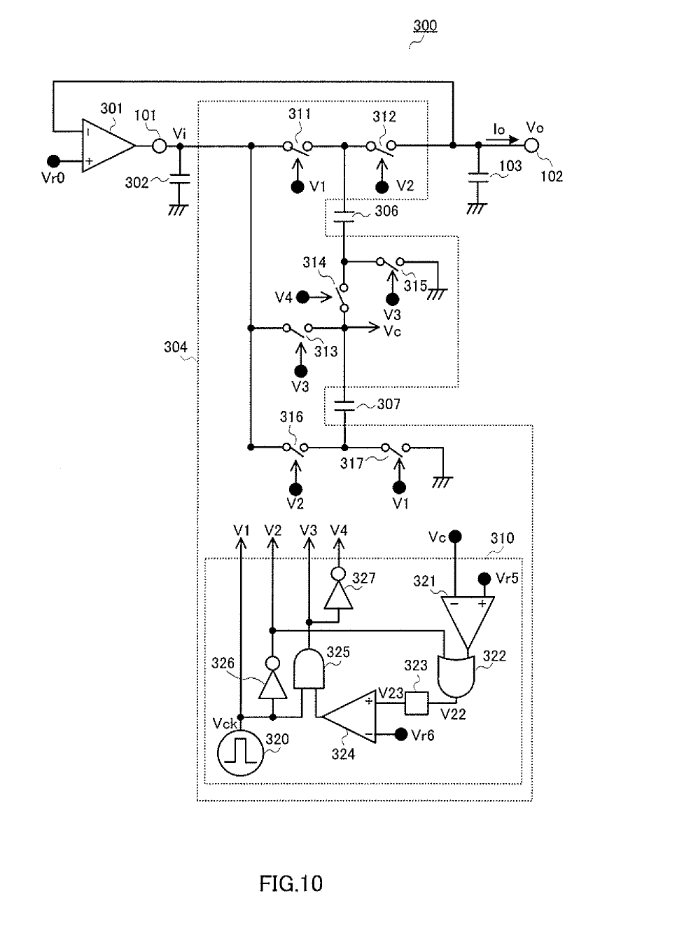

FIG. 10 is a circuit configuration diagram of a charge pump circuit according to Embodiment 3 of the present invention. With reference to FIG. 8, for a description of this embodiment, the same numbers are assigned to the same units as shown in FIG. 6.

With reference to FIG. 10, charge pump circuit 300 comprises: input terminal 101 to which an input voltage Vi is applied; output terminal 102 which outputs an output voltage Vo and an output current Io; output capacitor 103 which is connected between output terminal 102 and the ground, and smoothes the output of charge pump circuit 300; stabilizing power supply circuit 301 which adjusts the input voltage Vi to charge pump circuit 300 so that the output voltage Vo of charge pump circuit 300 reaches the target voltage Vr0; smoothing capacitor 302 which smoothes an input voltage Vi received from stabilized power supply circuit 301; detection control section 310; switching circuit 304 which is comprised of switch element 311, switch element 312, switch element 313, switch element 314, switch element 315, switch element 316 and switch element 317; first flying capacitor 306, one end of which is connected to a connection point between switch element 311 and switch element 312 and the other end of which is connected to a connection point between switch element 314 and switch element 315; and second flying capacitor 307, one end of which is connected to a connection point between switch element 313 and switch element 314 (i.e. a detection point), and the other end of which is connected to a connection point between switch element 316 and switch element 317. First flying capacitor 306 and second flying capacitor 307 have the same capacitance C.

Switch element 311 and switch element 312 are serially connected between input terminal 101 and output terminal 102. Switch element 313, switch element 314, and switch element 315 are serially connected between input terminal 101 and the ground. Switch element 316 and switch element 317 are serially connected between input terminal 101 and the ground.

Detection control section 310 comprises: oscillation circuit 320 which outputs a clock signal Vck of a 50, duty cycle; comparator 321 which compares a detected voltage Vc with a reference voltage Vr5; OR circuit 322 which receives the output of comparator 321 and a drive signal V2 and outputs a signal V22; averaging circuit 323 which averages the output of comparator 321 and outputs a signal V23; comparator 324 which compares the output of averaging circuit 323 with a reference voltage Vr6; NAND circuit 325 which receives the output of comparator 324 and the clock signal Vck, and outputs a drive signal V3; inverter 326 which inverts the clock signal Vck; and inverter 327 which inverts the drive signal V3 received from NAND circuit 325 and outputs a drive signal V4. The clock signal Vck of a 50% duty cycle output from oscillation circuit 320 is output as a drive signal V1.

Detection control section 310 detects the voltage Vc of a connection point between switch element 313 and switch element 314, outputs a drive signal V1 for driving switch element 311 and switch element 317, a drive signal V2 for driving switch element 312 and switch element 316, a drive signal V3 for driving switch element 313 and switch element 315, and a drive signal V4 for driving switch element 314.

Now, the operation of the above-configured charge pump circuit 300 will be described.

[3-Fold Voltage Boost Operation]

First, 3-fold voltage boost operation will be described, in which the output voltage of charge pump circuit 300 is three times the input voltage Vi when the output current Io is large.

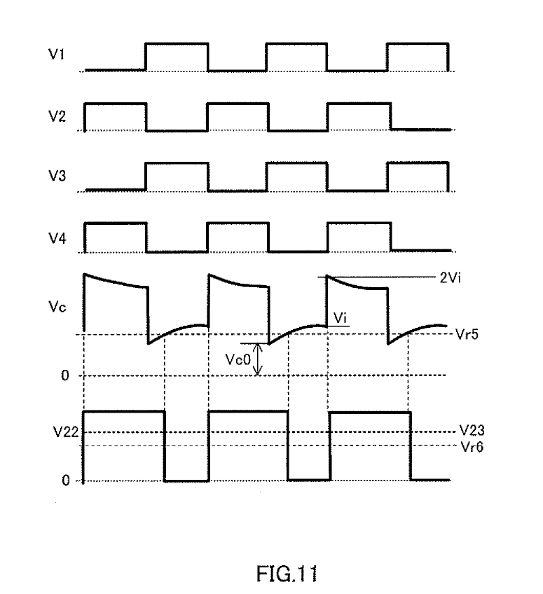

FIG. 11 shows the operation waveforms for individual operation points of charge pump circuit 300 in 3-fold voltage boost operation, and the waveforms include drive signal V1, drive signal V2, drive signal V3 and drive signal V4, detected voltage Vc, and V23, which is the output of averaging circuit 323, and which is the average value of the logical sum V22 of the output of comparator 321 and drive signal V2.

With reference to FIG. 11, during 3-fold voltage boost operation, the drive signal V1 is in phase with the drive signal V3, the drive signal V2 is in phase with the drive signal V4, and the drive signal V1 is out of phase with the drive signal V2. When the drive signal V1 is at a high level, switch elements 311, 313, 315 and 317 close, and the other switch elements open. At this time, first flying capacitor 306 and second flying capacitor 307 are connected in parallel and are applied an input voltage Vi, providing a charge state where the charge current flows. If the period of charge is enough, both flying capacitors 306 and 307 are charged to the input voltage Vi. When the drive signal V1 is at a low level, switch elements 312, 314, and 316 close, and the other switch elements open. At this time, first flying capacitor 306 and second flying capacitor 307 are connected serially between input terminal 101 and output terminal 102, providing a discharge state. If the resistance occurring when the switch elements are closed and the voltage variation due to the charge or discharge of the flying capacitors are ignored, the output voltage Vo becomes 3×Vi, adding the charge voltage of serially connected flying capacitors 306 and 307, 2Vi, to the input voltage Vi. In practice, the above voltage variation cannot be ignored. Although no illustration is provided, the voltages of both flying capacitors provide waveforms that rise during charge and drop during discharge. Consequently, as shown in FIG. 11, the detected voltage Vc rises from the initial value Vc0 to the input voltage Vi in the charge state, and the detected voltage Vc drops from the input voltage 2Vi in the discharge state.

The output current Io is expressed by the following equation (10):
Io=f·C·ΔV (10)
where f indicates the frequency of the clock signal and ΔV indicates the value of the voltage variation of the detected voltage Vc in the charge state.

If first flying capacitor 306 and second flying capacitor 307 have sufficient time for charge and discharge, the voltage variation ΔV is expressed as follows:
ΔV=Vi-(Vo-Vi)/2=1.5Vi-Vo/2

From the above equation (10), the relationship of the input voltage and the output voltage is expressed as follows:
Vo=3Vi-2Io/(f·C) (11)

The initial value of the detected voltage Vc is expressed as Vi-ΔV in the charge state where the input voltage Vi is charged to second flying capacitor 307. From the above equation (10), this initial value Vc0 is expressed as the following equation (12) and decreases in proportion to the output current Io. Accordingly, the output current level can be sensed from the detected voltage Vc.
Vc0=Vi-ΔV=Vi-Io/(f·C) (12)

Next, the operation of detection control section 310 in 3-fold voltage boost operation will be described.

In the state of heavy load where the output current Io is larger than a predetermined value, the initial value Vc0 of the voltage Vc detected in the charge state is lower than the reference voltage Vr3, and comparator 321 generates a pulse. The logical sum V22 of this pulse and drive signal V2 is averaged in averaging circuit 323 and produces the voltage V23, and, when this voltage V23 is larger than a reference voltage Vr6, the comparator 324 outputs a high level signal. By AND circuit 325, the drive signal V3 is made a signal in phase with the drive signal V1 and output, and the drive signal V4 is made a signal in phase with the drive signal V2 and output.

The above is the 3-fold voltage boost operation of charge pump circuit 300.

[2-Fold Voltage Boost Operation]

Next, 2-fold voltage boost operation will be described, in which the output voltage is approximately twice the input voltage Vi when the output current is little.

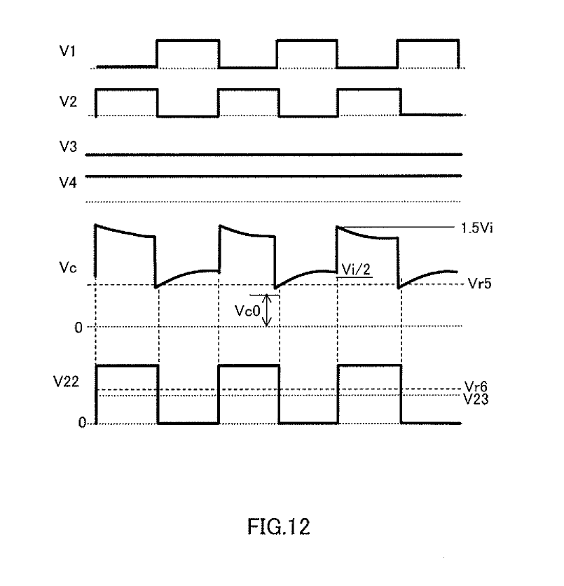

FIG. 12 shows the operation waveforms of individual operation points of charge pump circuit 300 in 2-fold voltage boost operation, and the waveforms include drive signal V1, drive signal V2, drive signal V3, drive signal V4, detected voltage Vc, and V23, which is the output of averaging circuit 323, and which is the average value of the logical sum V22 of the output of comparator 321 and drive signal V2.

With reference to FIG. 12, during 2-fold voltage boost operation, the drive signal V1 and the drive signal V2 are in phase, and the drive signal V3 is fixed to a low level; and the drive signal V4 is fixed to a high level. At this time, switch element 314 is constantly closed, so that first flying capacitor 306 and second flying capacitor 307 are serially connected and can be seen as one capacitor having the capacitance C/2. Switch elements 313 and 315 are constantly open. When the drive signal V1 is at a high level, first flying capacitor 306 and second flying capacitor 307 that are serially connected via switch elements 311, 314 and 317 are applied the input voltage Vi, providing a charge state where the charge current flows. If the period of charge is enough, the voltage of serially connected flying capacitors 306 and 307 is charged to the input voltage Vi.

Next, when the drive signal V1 is at a low level, serially connected first flying capacitor 306 and second flying capacitor 307 are connected between input terminal 101 and output terminal 102 via switch elements 316, 314 and 312, providing a discharge state. If the resistance occurring when the switch elements are closed and the voltage variation due to the charge or discharge of the flying capacitors are ignored, the output voltage Vo becomes 2×Vi, adding the charged voltage Vi of serially connected flying capacitors 306 and 307 on top of the input voltage Vi. In practice, the above voltage variation cannot be ignored. Although no illustration is provided, the voltage of both flying capacitors 306 and 307 provide waveforms that rises during charge and drops during discharge. With reference to FIG. 12, the detected voltage Vc rises from the initial value Vc0 to Vi/2 in the charge state, and drops from the input voltage 1.5 Vi in the discharge state. The output current Io is expressed as follows:
Io=f·C·ΔV (13)
where f indicates the frequency of the clock signal, and ΔV indicates the value of voltage variation of the detected Vc in the charge state.

If the period of charge for first flying capacitor 306 and second flying capacitor 307 is enough, the voltage variation ΔV is expressed as follows;
ΔV=Vi/2-(Vo-Vi)/2=Vi-Vo/2
From the above equation (13), the relationship of the input voltage and the output voltage is expressed as follows:
Vo=2Vi-2Io/(f·C) (14)

The initial value of the detected voltage Vc is expressed as Vi/2-ΔV in the charge state where the input voltage Vi is charged to second flying capacitor 307. From the above equation (13), this initial value Vc0 is expressed by the following expression (15) and decreases in proportion to the output current Io. Accordingly, the output current level can be sensed from the detected voltage Vc.
Vc0=Vi/2-ΔV=Vi/2-Io/(f·C) (15)

Next, the operation of detection control section 310 in 2-fold voltage boost operation will be described.

In the state of light load where the output current Io is smaller than a predetermined value, the initial value Vc0 of the detected voltage Vc in the charge state is high, and comparator 321 outputs a low level signal having a narrow pulse width. As a result, the voltage V23 which is averaged by averaging circuit 323 is less than the reference voltage Vr6, and comparator 324 outputs a low level signal. AND circuit 325 fixes the drive signal V3 at a low level and the drive signal V4 at a high level.

[Switching Operation Between 3-Fold Voltage Boost Operation and 2-Fold Voltage Boost Operation]

In this embodiment, with stabilizing power supply circuit 301, the input voltage Vi changes so that the output voltage Vo is stabilized toward the target value Vr0. From the equation (11), the input current Vi in 3-fold voltage boost operation is expressed by the following equation (16).
Vi=Vo/3+2Io/(3f·C) (16)

From the above equation (14), the input current Vi during 2-fold voltage boost operation is expressed by the following equation (17):
Vi=Vo/2+Io/(f·C) (17)

Assuming that the maximum input voltage that stabilized power supply circuit 301 can output is Vix, the maximum output current Iox in 2-fold voltage boost operation is expressed by the following equation (18):
Iox=f·C·(Vix-Vo/2) (18)

Iox of this equation (18) and Vi obtained by the above expression (17) are assigned to Io of the above expression (15) to obtain Vc0. Then, a value sufficiently higher than Vc0 is required to be set for reference voltage Vr5. This Vr5 is expressed by the following equation (19):
Vr5>(Vo-Vix)/2 (19)

During 3-fold voltage boost operation, when the output current Io is Iox, Vi=2Vix/3 from the equation (16) and Vc0=Vo/2-Vix/3. This value is larger than the right part of the equation (19). Thus, in 3-fold voltage boost operation, Vr5 needs to be set greater than in 2-fold voltage boost operation.

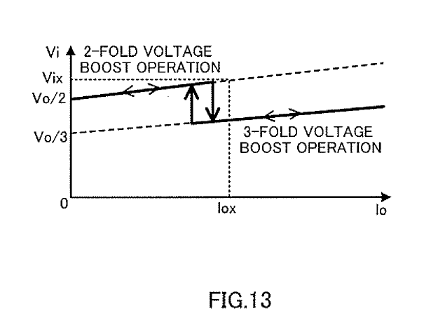

FIG. 13 shows the characteristics of the input voltage Vi and the output voltage Vo in charge pump circuit 300 operating as described above. FIG. 13 shows input and output characteristics of charge pump circuit 300. By changing the timing of switching the switch elements between the case of the shift from 2-fold voltage boost operation to 3-fold voltage boost operation and the case of the shift from 3-fold voltage boost operation to 2-fold voltage boost operation, hysteresis is provided to prevent the switching operations from hunting.

As mentioned above, according to this embodiment, charge pump circuit 300 is provided with stabilizing power supply circuit 301 to stabilize the output voltage Vo, and senses the output current level from the detected voltage Vc of second flying capacitor 307, and, utilizing these, enables switching operations between 2-fold voltage boost operation and 3-fold voltage boost operation. The maximum value of the detected voltage Vc is 1.5 Vi (=3Vo/4) in 2-fold voltage boost operation and 2Vi (=2Vo/3) in 3-fold voltage boost operation. Accordingly, the detected voltage Vc is lower than the output voltage Vo, enabling a low voltage withstanding level of the detection section. As mentioned above, by employing a configuration of adjusting the input voltage for output control, detection level correction by selected operations, and, in addition, detection level correction by the input voltage become unnecessary.

The charge pump circuit which can switch 2-fold voltage boost operation and 3-fold voltage boost operation is not limited to the configuration shown in FIG. 10. The charge pump circuit applies to other configurations, including step-down voltage charge pump circuits and charge pump circuits for 1.5-fold voltage boost operation and 2-fold voltage boost operation. Other configurations will be described below.

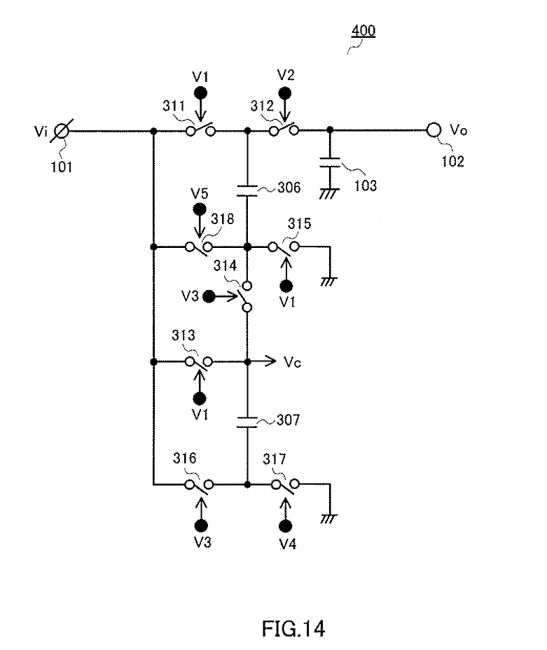

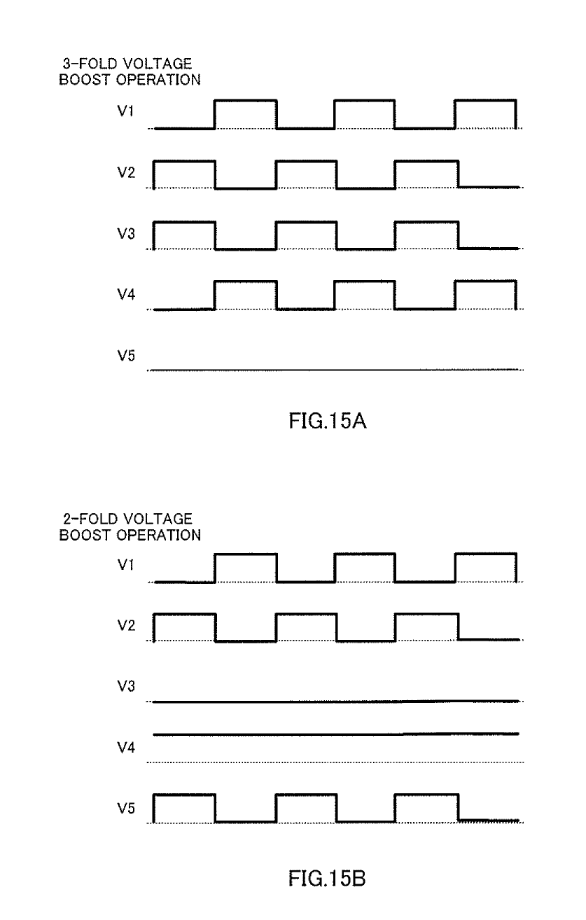

FIG. 14 shows another circuit configuration diagram of a charge pump circuit that operates in 2-fold voltage boost operation, and FIG. 15 shows the operation waveforms of the charge pump circuit shown in FIG. 14. With reference to FIG. 10, the same numbers are assigned to the same as in the charge pump circuit as shown in FIG. 8 and the description of the detection control section is omitted.

With reference to FIG. 14, charge pump circuit 400 adds switch element 318 to the configuration of charge pump circuit 300 shown in FIG. 10. Switch element 318 is connected between input terminal 101 and the low potential side of first flying capacitor 306. Providing drive signals as shown in FIGS. 15A and 15B enables 2-fold voltage boost operation using only first flying capacitor 306. In this case, the voltage of first flying capacitor 306 is the detected voltage Vc.

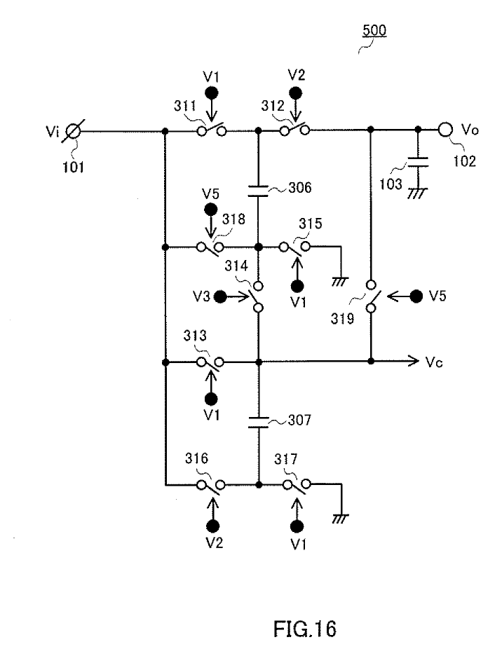

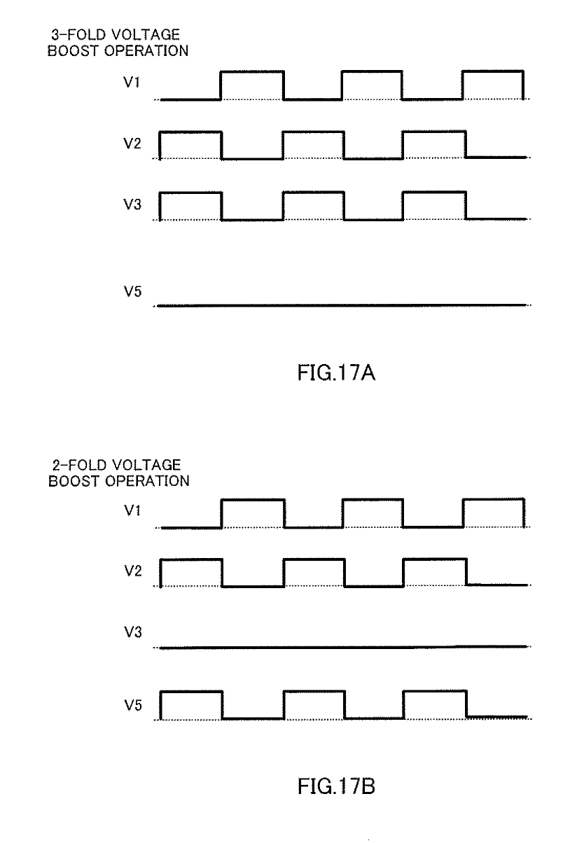

FIG. 16 is another circuit configuration diagram of a charge pump circuit operating in 2-fold voltage boost operation. FIG. 17 shows the operation waveforms of the charge pump circuit shown in FIG. 16. With reference to FIG. 14, the same numbers are assigned to the same units of the charge pump circuit as shown in FIG. 12.

With reference to FIG. 16, charge pump circuit 500 adds switch element 319 to the configuration of charge pump circuit 400 shown in FIG. 14. Switch element 319 is connected between output terminal 102 and the high potential side of second flying capacitor 307. Providing drive signals as shown in FIGS. 17A and 17B enables 2-fold voltage boost operation using parallel capacitors of first flying capacitor 306 and second flying capacitor 307. In this case, the voltage of second flying capacitor 307 is the detected voltage Vc.

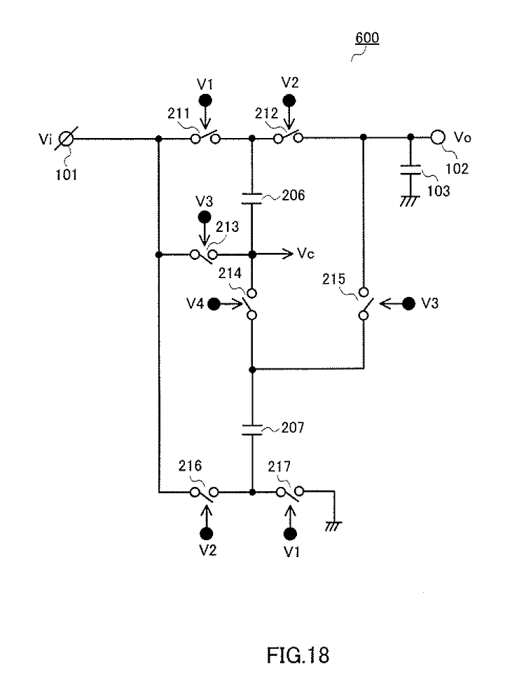

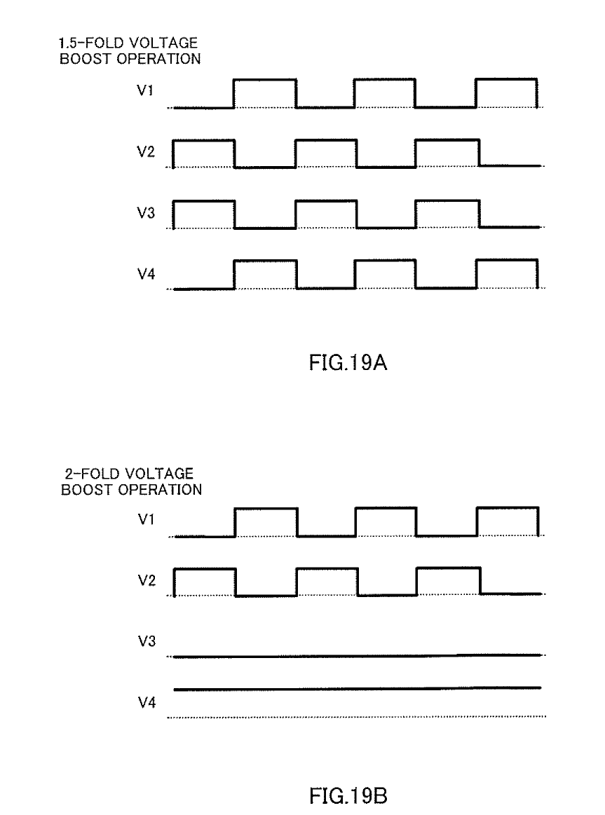

FIG. 18 is another circuit configuration diagram of a charge pump circuit for 1.5-fold voltage boost operation and 2-fold voltage boost operation, and FIG. 19 shows the operation waveforms of the charge pump circuit shown in FIG. 18.

Charge pump circuit 600 shown in FIG. 18 adopts the same switch element configuration as in Embodiment 2 shown in FIG. 6. Providing drive signals as shown in FIGS. 19A and 19B enables 2-fold voltage boost operation using series capacitors of first flying capacitor 206 and second flying capacitor 207, in addition to the 1.5-fold voltage boost operation described in Embodiment 2. In this case, the voltage of second flying capacitor 207 is the detected voltage Vc.

The current detection method used for the charge pump circuit according to this invention is applicable not only to step-up voltage charge pump circuits, but also to step-down voltage charge pump circuits, and inverted charge pump circuits, regardless of circuit configuration.

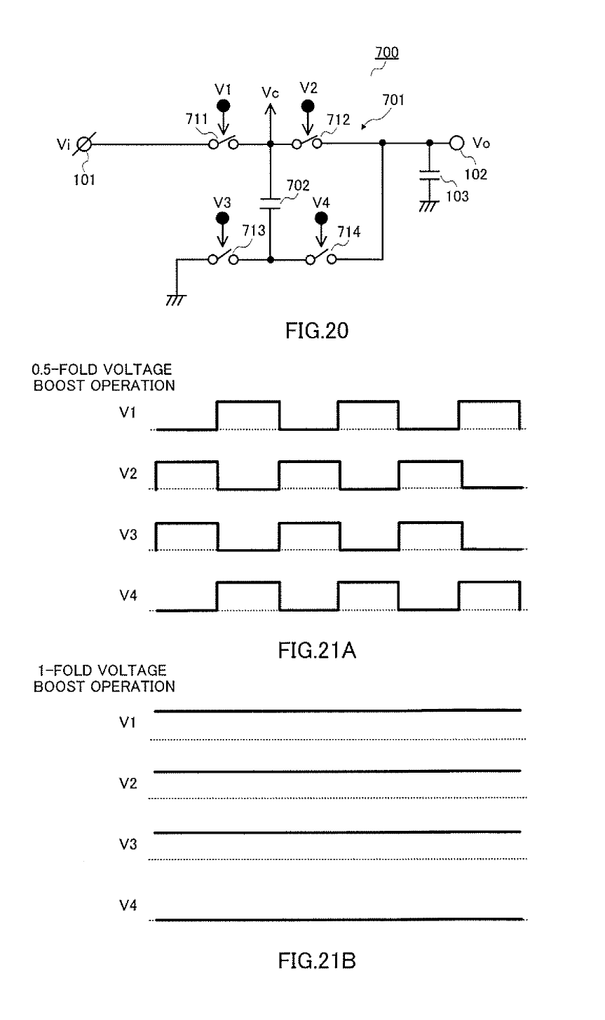

FIG. 20 is a circuit configuration diagram of a charge pump circuit operating in 0.5-fold voltage boost operation, and FIG. 21 shows the operation waveforms of the charge pump circuit shown in FIG. 20. With reference to FIG. 18, the same numbers are assigned to the same units of the charge pump circuit 200 as shown in FIG. 4.

With reference to FIG. 20, step-down voltage charge pump circuit 700 for 0.5-fold voltage comprises: switching circuit 701 which is comprised of switch element 711, switch element 712, switch element 713, and switch element 714, and flying capacitor 702, one end of which is connected to a connection point between switch element 711 and switch element 712 (i.e. a connection point), and the other end of which is connected to a connection point between switch element 713 and switch element 714.

FIG. 21A shows the operation waveforms during 0.5-fold voltage boost operation and FIG. 21B shows the operation waveforms during 1.0-fold voltage boost operation. With reference to FIG. 19, the output current level can be sensed from the detected voltage Vc of flying capacitor 702 in the same manner as described in the above embodiments. Accordingly, this enables switch between 0.5-fold voltage boost operation and 1.0-fold voltage boost operation. Note that the threshold for the detection level may need to be corrected depending on the operation mode or the input voltage.

The above descriptions are only illustrative of preferred embodiments of the present invention, and the scope of the present invention is not limited to these embodiments. For example, the above embodiments are examples of charge pump circuit applications. However, the present invention is applicable to any equipment sensing the output current from the output terminal based on the detected voltage Vc of a flying capacitor. For example, the present invention may be applied to a DC-DC converter and a power supply circuit including a charge pump circuit.

The above embodiments have been described using names such as “charge pump circuit” and “power supply apparatus.” However, these names are used solely for the convenience of explanation and may be reworded to, for example, “voltage converting circuit,” “output voltage detection circuit,” and “power supply circuit with a current detection function.”

Moreover, the present invention is by no means limited to the above charge pump circuit elements, including the types, number and connection method of switch elements.

As mentioned above, according to the present invention, the output current can be sensed by detecting the voltage of a flying capacitor. High efficiency power conversion is enabled by an operation based on a conversion scale corresponding to the sensed output current level. In step-up voltage operation using a plurality of flying capacitors, an advantage is provided that the detection section enables a low voltage withstanding level by detecting the voltage of a connection point of serially connected flying capacitors and requires less footprint. Moreover, by adjusting the input voltage and stabilizing the output, enabling an easy selection of circuit configuration corresponding to the output current level.

Accordingly, the pump circuit and power supply apparatus according to the present invention are useful as power supply circuits for electronic devices such as mobile devices. The present invention is furthermore widely applicable to charge pump circuits and power supply apparatuses for use in other electronic devices than mobile devices.

The present invention is not limited to the above described embodiments, and various variations and modifications may be possible without departing from the scope of the present invention.

This application is based on Japanese Patent Application No. 2005-365408, filed on Dec. 19, 2005, the entire content of which is expressly incorporated by reference herein.

What is claimed is:

1. A charge pump circuit comprising:
an input terminal and an output terminal;
at least one flying capacitor;
a plurality of switch elements;
a switching circuit that performs a switching operation of alternately switching between a charge state of charging an electric charge of the flying capacitor from the input terminal and a discharge state of discharging the electric charge of the flying capacitor to the output terminal; and
a detection section that detects a voltage of the flying capacitor and senses an output current from the output terminal based on the detected voltage.

2. A charge pump circuit comprising:
an input terminal and an output terminal;
a first switch element and a second switch element connected in series between the input terminal and the output terminal;
at least one flying capacitor, one end of said flying capacitor being connected to a connection point between the first switch element and the second switch element;
a switching circuit that performs a switching operation of alternately switching between a charge state of charging the flying capacitor from the input terminal and a discharge state of discharging the flying capacitor to the output terminal with a plurality of switch elements including the first switch element and the second switch element; and
a detection section that detects a voltage of the flying capacitor and senses an output current from the output terminal based on the detected voltage.

3. The charge pump circuit according to claim 1, wherein the detection section senses the output current from the output terminal according to a relationship equation determining a difference or a ratio between an initial value of the detected voltage and an input voltage during the charge of the flying capacitor.

4. The charge pump circuit according to claim 1, comprising a plurality of flying capacitors, wherein, when the plurality of flying capacitors are serially connected by the switching circuit, the detection section detects a voltage at a connection point of the serially connected flying capacitors.

5. The charge pump circuit according to claim 1, wherein the switching circuit performs one of: the switching operation of alternately switching between the charge state of charging the electric charge of the flying capacitor from the input terminal and the discharge state of discharging the electric charge of the flying capacitor to the output terminal; and a 1-fold operation of connecting the input terminal and the output terminal.

6. The charge pump circuit according to claim 1, wherein, based on an output of the detection section, the switching circuit selects one of a plurality of switching operations combining a plurality of charge states and a plurality of discharge states.

7. The charge pump circuit according to claim 1, wherein, based on an output of the detection section, the switching circuit selects one of: a plurality of switching operations combining a plurality of charge states and a plurality of discharge states; and a 1-fold operation.

8. The charge pump circuit according to claim 1, wherein the detection section comprises:
a reference voltage generation circuit; and
a comparator that compares a voltage of the flying capacitor in the charge state or the discharge state with a voltage of the reference voltage generation circuit.

9. The charge pump circuit according to claim 8, wherein the detection section comprises an averaging circuit that averages signals including an output of the comparator.

10. The charge pump circuit according to claim 8, wherein the reference voltage generation circuit generates a voltage in accordance with an input voltage of the input terminal or the charge state or the discharge state of the switching circuit.

11. The charge pump circuit according to claim 1, further comprising a voltage stabilizing circuit that adjusts an input voltage to be applied to the input terminal to stabilize an output voltage from the output terminal.

12. A power supply apparatus comprising:
a flying capacitor;
a switching circuit that performs a switching operation of alternately switching between the charge state of charging the electric charge of the flying capacitor from the input terminal and the discharge state of discharging the electric charge of the flying capacitor to the output terminal; and
a detection section that detects a voltage of the flying capacitor and senses an output current output from the output terminal based on the detected voltage.

13. The power supply apparatus according to claim 12, wherein the detection section senses the output current from the output terminal according to a relationship equation determining a difference or a ratio between an initial value of the detected voltage and an input voltage during the charge of the flying capacitor.
